(19) United States
(12) Patent Application Publication
(10) Pub. No.: US 2015/0118433 A1
(43) Pub. Date: Apr. 30, 2015

(54) REPLACEABLE DOOR, WINDOW, AND FURNITURE COVERING

(71) Applicant: Shohreh Khorsandi, Seattle, WA (US)

(72) Inventor: Shohreh Khorsandi, Seattle, WA (US)

(21) Appl. No.: 14/069,094

(22) Filed: Oct. 31, 2013

(51) Int. Cl. E04F 13/00; A47C 31/10; B44F 7/00

(52) U.S. Cl. CPC E04F 13/002; B44F 7/00; A47C 31/10
USPC 428/42.1; 428/195.1; 428/43; 428/40.1; 428/343; 428/172

(57) ABSTRACT

Methods and articles of manufacture are disclosed for easily changing the look and appearance of doors, windows, furniture, appliances and the like. The protection, refurbishing, and/or redecoration of items may be permanent or temporary, partial or complete. The disclosed laminates may be two or three dimensional and be self-adhesive or non-self-adhesive. In some embodiments both sides of the laminate may be self-adhesive. In other embodiments the laminates may be used as canvas to create permanent or removable art work.

### TECHNICAL FIELD

This application relates generally to lamination. More specifically, this application relates to methods and articles of manufacture for temporary and permanent surface covering of doors, windows, appliances, and furniture.

### BRIEF DESCRIPTION OF THE DRAWINGS

The drawings, when considered in connection with the following description, are presented for the purpose of facilitating an understanding of the subject matter sought to be protected.

FIG. 1 shows an example of a refurbishing door laminate;

FIG. 2 shows an example of a 3-D redecorating door laminate; and

FIG. 3 shows an example of a partial temporary door covering configured to be used for writing or artwork.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while the following description mostly references using layers of decorative paper laminates for covering surfaces of doors and windows, it will be appreciated that the disclosure may include many other synthetic or natural materials such as plastic or wooden sheets of laminates for covering doors, windows and other household and office articles such as appliances and furniture, and the like.

Briefly described, methods and articles of manufacture are disclosed including a surface covering having various patterns and colors for easily changing the look and appearance of doors, windows, furniture, appliances and the like. The repairing, resurfacing, refurbishing and/or redecorating items may be permanent or temporary, partial or complete. The surface covering may be opaque, transparent, or a combination of both. In various embodiments, the surface covering may also be a scratch resistant, abrasion resistant, or stain resistant protective laminate to protect the covered surface against scratches, stains, UV (Ultra Violate) light discoloration, and the like. In other various embodiments, the surface covering may be pre-fitted for a particular surface contour such as door and window panels, raised trims, or other similar raised and/or recessed patterns on 3-D surface curves. In still other embodiments, the surface covering may be applied to a non-flat and non-smooth surface having raised or recessed carvings, using UV, chemical, or thermal activation to soften and attach the surface covering to the desired surface smoothly and without additional wrinkles. In some embodiments, the surface covering may have a self-adhesive side for temporary or permanent bonding with the intended surface.

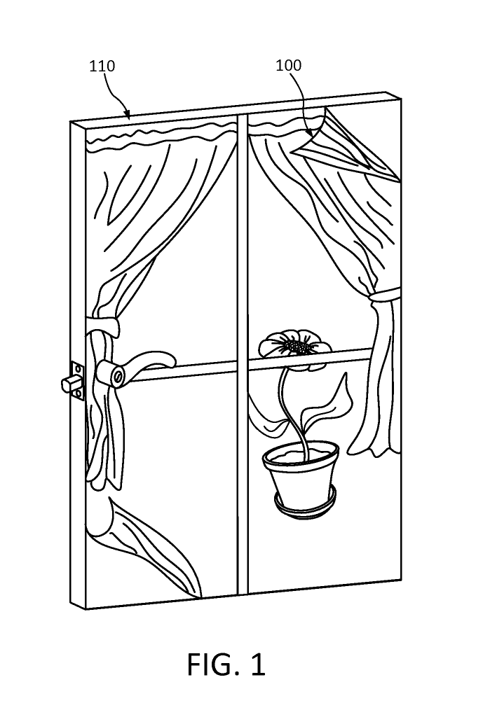

FIG. 1 shows an example of a refurbishing door laminate. In this example a disclosed laminate 100, which creates illusion of looking out a window into a garden, is being affixed to a plain old door 110. Similar laminates may be used on any plain old door to create illusion of looking, for example, at a new mahogany six-panel door. The disclosed laminates can be used to merely liven up the interior of a small room or apartment. In various embodiments the laminate may be manufactured from sheets of synthetic or natural materials or a combination of synthetic and natural materials. These sheets may be self adhesive, with a peel-off protective layer or may require using adhesive material such as glue and epoxy. In some embodiments permanent glue and in other embodiments non-permanent glue may be used. In various embodiments the disclosed laminates may be either used to cover the entire surface of an object such as a door or a part of the surface. For example the disclosed laminates may be used to cover the surface of a child's bedroom door which is facing the inside of the room such that the surface facing the hallway remains untouched. In some embodiments the disclosed laminates may be used as a painter's canvas or for writing notes. For example the bedroom door of a child or a youth may be temporarily covered, partially or completely, with laminates that allow him/her to write or paint over them. These laminates may be plain or already have some basic designs printed over them or even be three dimensional. In some embodiments the laminates may be cleanable or even washable. In other embodiments the laminates may be luminescent and/or heat and light sensitive.

In other various embodiments, the surface covering may be pre-fitted for a particular surface contour such as door and window panels, raised trims, or other similar raised and/or recessed patterns on 3-D surface curves. This arrangement allows a smooth pre-fabricated fit for common windows, doors, furniture carvings, and the like without excessive fitting effort in the field, which may not be practical for intricate carvings and trims. In some embodiments, a 3-D scan of a desired non-standard or standard surface may be obtained to allow the manufacturing of a custom-built surface covering for the desired surface. This process may be cost effective if a 3-D scanned image can be obtained using scanning/mapping devices, such as cameras or laser scanners, and stored in a standard format required by the manufacturer and electronically transmitted to the manufacturer with the customer order for the surface covering.

In still other embodiments, the surface covering may be applied to a non-flat and non-smooth surface having raised or recessed carvings, using UV, chemical, or thermal activation to soften and attach the surface covering to the desired surface smoothly and without additional wrinkles.

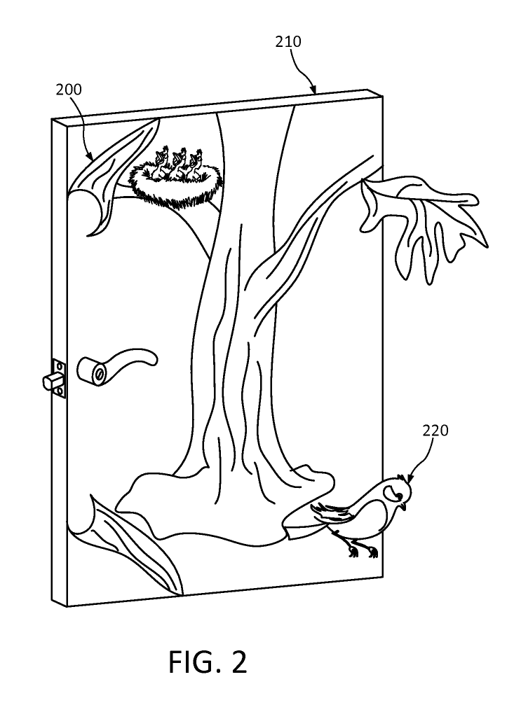

FIG. 2 shows an example of a 3-D redecorating door laminate. In some embodiments these sheets may be flat on both sides and in other embodiments these sheets may be flat on one side and three dimensional on the other side. For example a redecorating sheet 200 used for covering a child's bedroom door 210 may have protruding dolls and animal FIGS. 220. Another example is temporary redecoration of an entrance door during Christmas, Thanksgiving, and Halloween.

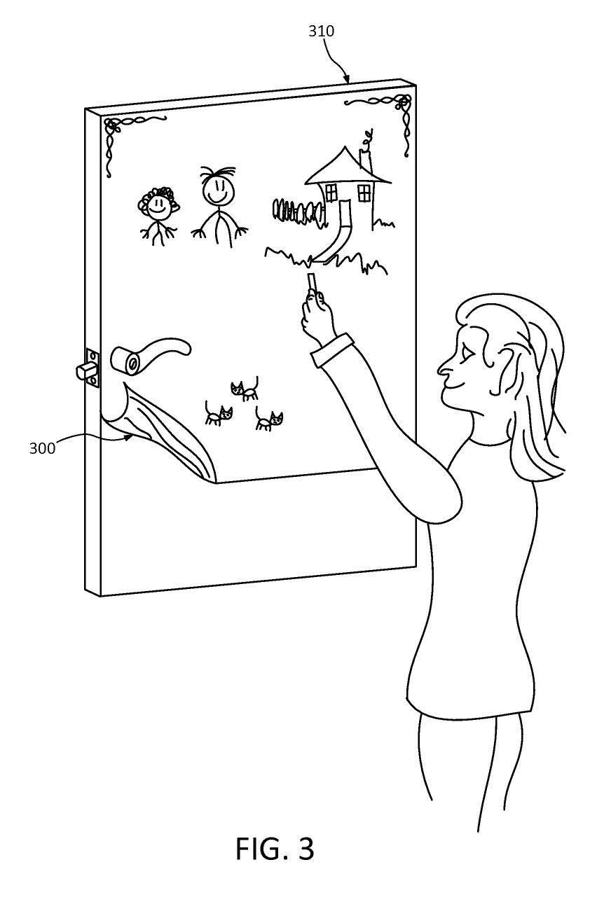

FIG. 3 shows an example of a partial and temporary door covering being used for writing or artwork. As shown in FIG. 3, a part of laminate 300 on door 310 is preprinted and a part of it is left blank for writing or painting. In some embodiments the laminates are pre-cut or pre-scored to fit the flat surfaces of standard doors and windows and in other embodiments the laminates may be preformed to cover and conform to protrusions and depressions of such standard non-planar object surfaces as standard six or four panel doors. In various embodiments personal pictures may be printed on the laminates.

Self-adhesive or non-self-adhesive laminates may be packaged in rolled, folded, flat, or stacked form. Some laminated having reusable glue, such as those used for Post-It Notes (sticky-notes) of 3M©, may be stacked together without protective sheets and be peeled off one by one.

In various embodiments both surfaces of the laminates may have permanent or reusable adhesive. For example, in one embodiment one side of the laminate may have a one-piece protective sheet that can be peeled off to stick the laminate to a door and the other side/surface of the laminate may partly or completely have a pre-scored protective sheet, parts of which can be peeled off to be able to stick notes, pictures, or other objects such as small dolls to the laminate. Such laminates may be used on the doors of school classes for different purposes and be removed at the end of each year or semester. They can also be used on the body of cars on different occasions and for different purposes. In general, the disclosed laminates may be used to replace painting new or old doors and windows. Laminates can further be used in those places where unwelcome graffiti need to be easily removed, such as school and university bathrooms.

Those skilled in the art will appreciate that many other types of laminates are possible without departing from the spirit of the present disclosures. For example, a laminate may consist of tree leaves stuck to a self-adhesive paper backing. Such laminate can be used for temporarily covering, for example, the entrance door or the refrigerator during autumn holidays, during which the laminate leaves will change color and may even fall. Different seasonal laminates may be temporarily applied to kitchen cabinets.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A self-adhesive surface covering laminate in sheet form for repairing, resurfacing, refurbishing, or redecorating of doors, windows, walls, shelves, furniture, home furnishings, and the like, the self-adhesive sheet comprising:
a sheet of synthetic, natural, or a combination of synthetic and natural materials having a front surface and a rear surface, the front surface further comprising images thereon;
an adhesive situated on the rear surface;
optionally, a temporary backing in contact with the adhesive such that the adhesive is sandwiched between the sheet and the temporary backing; and
wherein the backing is so configured to be stripped from contact with the adhesive to expose the adhesive such that the rear surface of the sheet can be applied to a surface.

2. The self-adhesive surface covering laminate of claim 1, wherein the images on the front surface are two-dimensional or three-dimensional.

3. The self-adhesive surface covering laminate of claim 1, wherein the laminate may be opaque, transparent, or a combination of both.

4. The self-adhesive surface covering laminate of claim 1, wherein the adhesive is permanent or non-permanent.

5. The self-adhesive surface covering laminate of claim 1, wherein the laminate is custom-made to cover and conform to raised and/or recessed patterns on a 3-D item the surfaces of which may be topologically mapped for manufacturing of the laminate by cameras, laser scanners, or other 3-D mapping devices.

6. The self-adhesive surface covering laminate of claim 1, wherein the laminate is preformed to cover and conform to protrusions and depressions of standard non-planar surfaces.

7. The self-adhesive surface covering laminate of claim 1, wherein the laminate is pre-scored.

8. The self-adhesive surface covering laminate of claim 1, wherein the laminate only partially covers an object's surface.

9. The self-adhesive surface covering laminate of claim 1, wherein the laminate sheet may be luminescent and/or heat and light sensitive.

10. A self-adhesive writing or painting surface covering laminate in sheet form for temporarily or permanently covering doors, windows, walls, shelves, furniture, appliance, home furnishings, and the like, the self-adhesive sheet comprising:
a sheet of woven or unwoven synthetic, natural, or synthetic and natural material having a front surface and a rear surface, the front surface configured to be painted or be written thereon;
an adhesive situated on the rear surface;
optionally, a temporary backing in contact with the adhesive such that the adhesive is sandwiched between the sheet and the temporary backing; and
wherein the backing is so configured to be stripped from contact with the adhesive to expose the adhesive such that the rear surface of the sheet can be applied to a surface.

11. The self-adhesive writing or painting surface covering laminate of claim 10, wherein the front surface is planar or is three-dimensional.

12. The self-adhesive writing or painting surface covering laminate of claim 10, wherein the surface covering laminate may be applied using UV, chemical, or thermal activation to soften and attach the surface covering to the desired surface smoothly and without wrinkles.

13. The self-adhesive writing or painting surface covering laminate of claim 10, wherein the adhesive is permanent or non-permanent.

14. The self-adhesive writing or painting surface covering laminate of claim 10, wherein the laminate does not include a temporary backing.

15. The self-adhesive writing or painting surface covering laminate of claim 10, wherein the laminate is preformed to cover and conform to protrusions and depressions of non-planar surfaces.

16. The self-adhesive writing or painting surface covering laminate of claim 10, wherein the laminate is pre-scored.

17. The self-adhesive writing or painting surface covering laminate of claim 10, wherein the laminate only partially covers an object's surface.

18. The self-adhesive writing or painting surface covering laminate of claim 10, wherein the laminate sheet may be luminescent and/or heat and light sensitive.

19. The self-adhesive writing or painting surface covering laminate of claim 10, wherein the laminate is custom-made to cover and conform to raised and/or recessed patterns on a 3-D item the surfaces of which may be topologically mapped for manufacturing of the laminate by cameras, laser scanners, or other 3-D mapping devices.

20. The self-adhesive writing or painting surface covering laminate of claim 10, wherein the front surface of the laminate sheet may have preprinted designs.
